(19) United States
(12) Patent Application Publication
(10) Pub. No.: US 2026/0151912 A1
(43) Pub. Date: Jun. 4, 2026

(54) UNMANNED ACCESS FLOOR CONSTRUCTION SYSTEM INCLUDING ALIGNMENT PLATE AND ACCESS FLOOR CONSTRUCTION METHOD USING SAME

(71) Applicants: SAMSUNG C&T CORPORATION, Seoul (KR); G-TEC CO., LTD., Cheonan-si, Chungcheongnam-do (KR)

(72) Inventors: Hae Moon JEON, Namyangju-si (KR); Sueunjae LEE, Seongnam-si (KR); Yunjae HEO, Incheon (KR); Kun Sub KIM, Seoul (KR); Bu Sik CHOI, Cheonan-si (KR); Jae Young KIM, Seoul (KR)

(73) Assignees: SAMSUNG C&T CORPORATION, Seoul (KR); G-TEC CO., LTD., Cheonan-si, Chungcheongnam-do (KR)

(21) Appl. No.: 19/122,541

(22) PCT Filed: Oct. 19, 2023
(86) PCT No.: PCT/KR2023/016221

§ 371 Date: Apr. 18, 2025

(30) Foreign Application Priority Data
Oct. 24, 2022 (KR) 10-2022-0137386

(51) Int. Cl. B25J 9/16; B25J 11/00; B25J 13/00; B25J 15/06; E04F 21/20

(52) U.S. Cl. CPC B25J 9/1687; B25J 11/005; B25J 13/006; B25J 15/0616; E04F 21/20

(57) ABSTRACT

The present disclosure relates to an unmanned access floor construction system including an installation frame, a floor coupled to the installation frame, and a pad that couples the floor to be correct position of the installation frame. The unmanned construction system, which is for an access floor, includes an unmanned robot connected to a control server through wired or wireless communication. The unmanned robot includes: a loading robot that loads the floor; an installation robot that moves and installs the floor loaded on the loading robot, to the installation frame; and an alignment unit that mounts the pad at a pad installation position of the floor when the installation robot moves the floor to the installation frame.

### TECHNICAL FIELD

The present invention relates an unmanned access floor construction system, and more particularly, to an unmanned access floor construction system that enable accurate and easy construction of an access floor without providing manpower by using a loading robot, an installation robot, and an alignment unit having a unique structure for the access floor construction, and an access floor construction method using the same.

### BACKGROUND ART

Access floor is a compound word of access (a computer term for putting or extracting information into or from a computer system) and a floor. Thus, the access floor is also called a double floor, a double bottom, or an O/A floor.

An access floor refers to a double floor proposed to secure a more comfortable and efficient office space in the information age in which the use of computers is increasing.

In general, in places that require clean or super-clean conditions, such as semiconductor fabs, TFT-LCD fabs, PDP fabs, pharmaceutical or food manufacturing plants, workshops for producing or assembling optical products, printing or precision machinery, and operating rooms, fine or ultrafine dust or mist have a significant impact on product quality. Thus, in addition to being strictly sealed from the outside, a clean room with a raised floor is provided to maintain a temperature and humidity within a specified range and prevent vibration through the constant temperature and humidity control.

The access floor is an additional floor formed by leaving a space at a certain height on a flat floor to satisfy the needs described above. In addition, the space is designed so that a cable is disposed in the space, and a bottom is openable for re-arranging the cable as necessary.

To construct the access floor, it is common to form an installation frame and allow a worker to form a pad and a floor on an upper portion of the installation frame.

When constructing the access floor, a safety net and lifeline have to be installed to ensure the safety of the worker, and thus, excessive costs and time are required to ensure the safety. In addition, since the floor is a heavy object having a weigh of several ten kg, the worker installing the floor is prone to musculoskeletal disorders, the leveling work of the heavy floor is very difficult, and the work has to be done at a place where there is a risk of falling, tripping, etc. during the installation.

In addition, when constructing the access floor at the place such as the fab, since the height of the installation frame is 3 m to 9 m, there is a risk of the falling of the worker, and thus, the constructing of the access floor is a task that is avoided by professional technicians. Thus, it is difficult to train skilled professional workers.

### DISCLOSURE OF THE INVENTION

### Technical Problem

The present invention has been made to solve the problems of the conventional access floor construction described above, and an object of the present invention is to provide an unmanned access floor construction system, in which an automated robot installs a mat and a floor without performing dangerous floor installation work by a worker to prevent safety accidents at a workplace from occurring, and an access floor construction method using the same.

Another object of the present invention is to provide an unmanned access floor construction system, in which selection of a floor installation position and a leveling work are quickly performed through installation of a mat and floor by a robot to reduce construction costs and shorten a construction period, and an access floor construction method using the same.

Further another object of the present invention is to provide an unmanned access floor construction system, in which a pad for coupling a plurality of floors at correct positions on the installation frame is disposed at a correct installation position of the floors, and an access floor construction method using the same.

Further another object of the present invention is to provide an access floor construction method, in which most of access floors are constructed using a robot to secure a certain level or higher of construction quality.

### Technical Solution

According to an aspect of the present invention, an unmanned access floor construction system, which includes an installation frame (10), floors (30) coupled to the installation frame (10), and pads (2) configured to couple the plurality of floors (30) at correct positions of the installation frame (10), includes: an unmanned robot connected to a control server (1) through wired or wireless communication, wherein the unmanned robot includes: a loading robot (100) configured to load each of the floors (30); an installation robot (200) configured to move the floor (30) loaded on the loading robot (100) up to the installation frame (10) so as to install the floor (30); and an alignment unit (300) configured to mount each of the pads (20) at a pad installation position (32) of the floor (30) when the installation robot (200) moves the floor (30) up to the installation frame (10).

In this case, the installation robot (200) may include: a robot arm (210); an adsorption part (220) disposed on the robot arm (210) to adsorb a top surface of the floor (30); and a latch (230) disposed on the robot arm (210) to surround a side hook protrusion (31) of the floor (30).

In addition, the loading robot (100) may include: a first loading part (110) configured to stack and load the plurality of floors (30); and a second loading part (120) configured to stack and load the plurality of pads (20).

In addition, the pad (20) may include: a mounting part (21) on which an edge of the floor (30) is mounted; a guide protrusion (22) configured to partition edges of the floor (30) and the adjacent floor (30a) from each other; and a second through-hole (23) into which a bolt (40) configured to couple the floor (30) and the pad (20) to the installation frame (10) is inserted.

In addition, when the pad (20) is disposed at the pad installation position (32), a first through-hole (32) and the second through-hole (23), into which the bolt (40) disposed on the floor (30) is inserted, may be aligned at the same position, and a lower edge of the floor (30) is in close contact with one side of the guide protrusion (22).

In addition, the installation robot (200) may include a pad installation part (240) configured to grip the pad (20) and insert the bolt (40) into the first through-hole (32) and the second through-hole (23).

In addition, the alignment unit (300) may include an alignment plate (310) on which the floor (30) and the pad (20) are mounted, wherein the alignment plate (310) may include: a first mounting part (311), on which the floor (30) is mounted; and a second mounting part (312), on which the pad (20) is mounted.

In this case, when the floor (30) is mounted on the first mounting part (311), and the pad (20) is mounted on the second mounting part (312), the pad (20) may be disposed at the pad installation position (32).

In addition, the alignment plate (310) may be erected at a predetermined angle.

In addition, the alignment plate (310) may further include a support protrusion (313) configured to support the floor (30) so that the floor (30) is mounted on the first mounting part (311).

In addition, the alignment plate (310) may further include a support groove (314) in which the pad (20) is inserted so that the pad (20) is mounted on the second mounting part (312).

According to another aspect of the present invention, an unmanned access floor construction method using the unmanned access floor construction system includes: a first process (S100) of lifting the floor (30) loaded on the loading robot (100) using the adsorption part (220) and the latch (230) of the installation robot (200); a second process (S200) of gripping the pad (20) using the pad installation part (240) of the installation robot (200) to lift the pad (20); a third process (S300) of mounting the floor (30) on the first mounting part (311) and mounting the pad (20) on the second mounting part (312) to allow the pad (20) to be disposed at the pad installation position (32); and a fourth process (S400) of mounting the pad (20) and the floor (30), which are mounted on the alignment plate (310), on the installation frame (10) using the robot arm (210) of the installation robot (200).

In this case, the unmanned access floor construction method may further include, after the fourth process (S400), a fifth process (S500) of inserting the bolt (40) into the first through-hole (32) and the second through-hole (23) using the pad installation part (240) to couple the floor (30) to the installation frame (10).

In addition, the fourth process (S400) may include: a proximity movement process (S410) of lifting the pad (20) and the floor (30) using the robot arm (210) to move to a vicinity of the installation frame (10); a latch releasing process (S420) of hinge-driving the latch (230) in a state, in which the adsorption of the adsorption part (220) on a top surface of the floor (30) is maintained, to release the latched state of the floor (30) on the side hook protrusion (31); and a seating process (S430) of seating the pad (20) and the floor (30) on a top surface of the installation frame (10).

According to further another aspect of the present invention, an access floor constructed through the unmanned access floor construction method is provided.

### Advantageous Effects

According to the present invention, the automated robot may install the mat and the floor without performing the dangerous floor installation work by the worker to prevent the safety accidents in the workplace from occurring.

According to the present invention, the selection of the installation position of the floor and the leveling work may be quickly performed through the installation of the mat and the floor by the robot to reduce the construction costs and shorten the construction period.

According to the present invention, the pad for coupling the plurality of floors at the correct position on the installation frame may be automatically disposed at the correct installation positions of the floors.

According to the present invention, the most of access floors may be constructed using the robot to ensure the certain level or higher of the construction quality.

### BRIEF DESCRIPTION OF THE DRAWINGS

FIGS. 1 to 3 are views illustrating a process of lifting a floor from a loading robot using a robot arm according to an embodiment of the present invention.

FIGS. 4 to 8 are views illustrating a process of lifting the floor from the loading robot using the robot arm to seat the floor on an installation frame according to an embodiment of the present invention.

FIGS. 10 to 19 are views illustrating a process of aligning the floor and a pad loaded on the loading robot using the robot arm so that the pad is disposed at a correct installation position according to an embodiment of the present invention.

FIG. 20 is a view illustrating a configuration of the alignment unit according to the present invention.

FIG. 21 is a view illustrating a configuration of the pad according to the present invention.

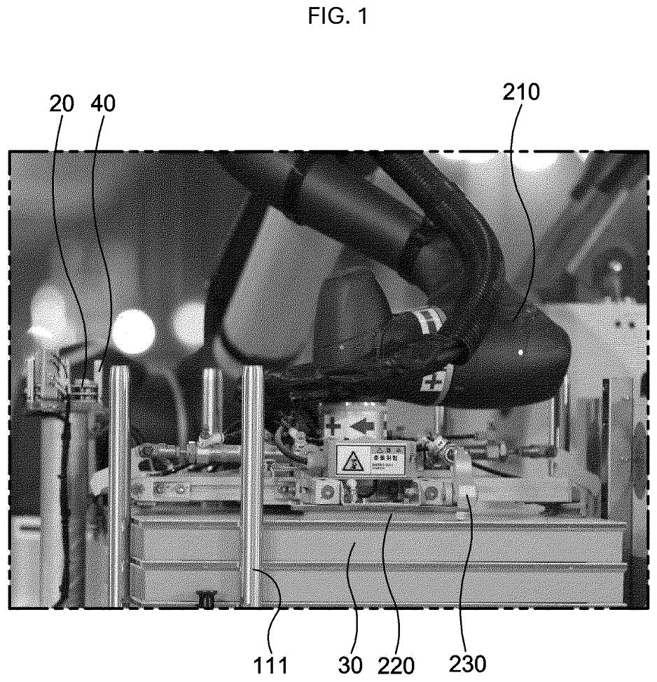

### MODE FOR CARRYING OUT THE INVENTION

An embodiment of an unmanned access floor construction system and an access floor construction method using the same according to the present invention will be described in detail with reference to the accompanying drawings. In the describing with reference to the accompanying drawings, identical or corresponding components are assigned the same drawing numbers, and duplicated descriptions thereof will be omitted.

In addition, the terms such as first, second, etc. used hereinafter are merely identifiers for distinguishing identical or corresponding components, and the identical or corresponding components are not limited by the terms such as the first, the second, etc.

In addition, the term “coupling” is used to refer not only to a case in which each component is physically in direct contact with the other components in the contact relationship between the components, but also to a case in which another component is interposed between the components, and each component is in contact with the other component.

The present invention relates to an unmanned access floor construction system that does not require manpower for construction of an access floor.

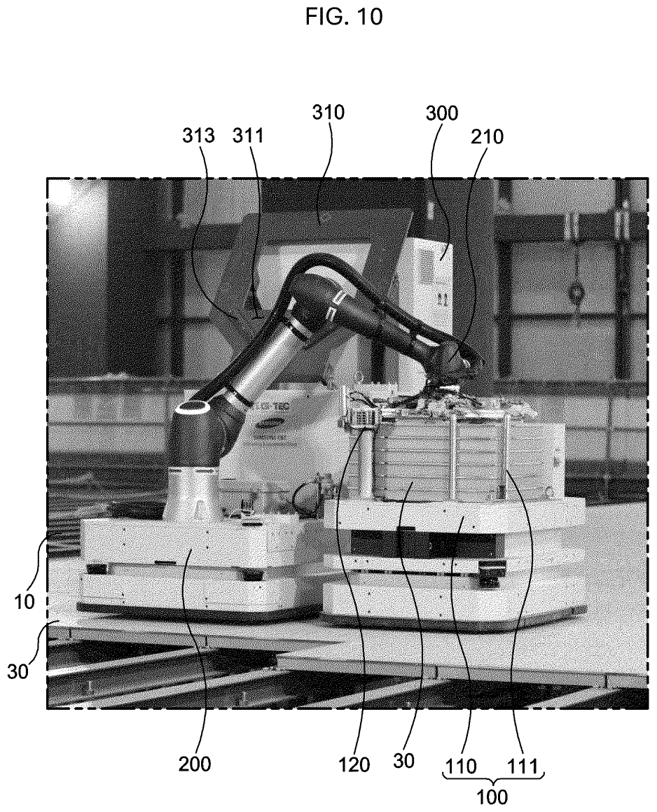

The unmanned access floor construction system according to an embodiment of the present invention may include an installation frame 10, floors 30 coupled to the installation frame 10, and a pad 20 that couples the plurality of floors 30 to correct positions of the installation frame 10 (see FIG. 10).

The installation frame 10 is a frame structure on which each of the floors 30 is mounted and which is constructed to be spaced a predetermined height from a bottom surface. Since the access floor is characterized by providing a space at a lower portion of the floor 30 to install system equipment, air conditioning equipment, etc., and thus, the installation frame 10 is constructed first, and the floor 30 is installed on an upper portion of the installation frame 10.

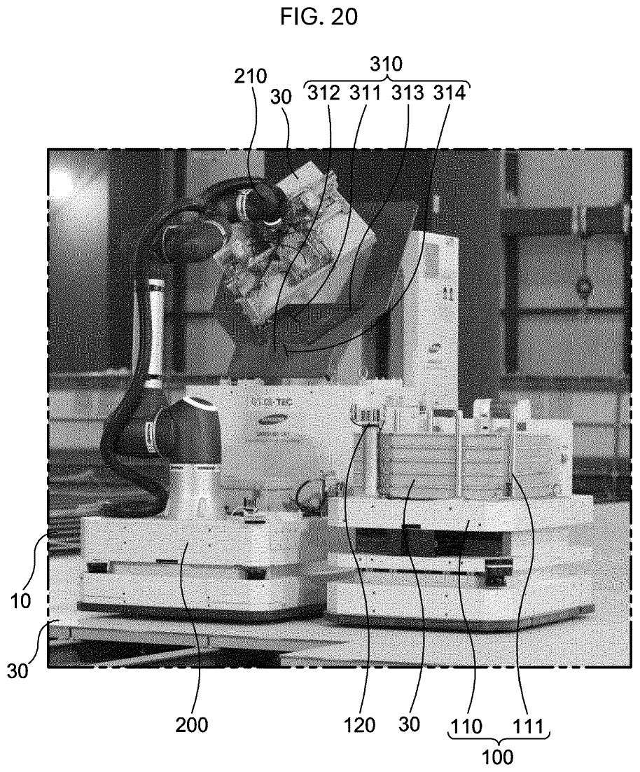

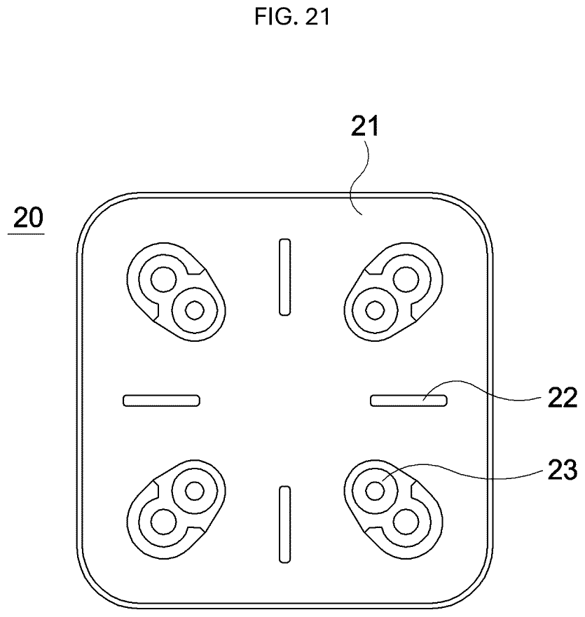

When installing the floor 30 on the upper portion of the installation frame 10, a pad that is illustrated in FIG. 20 is used to install the plurality of floors 30 in the correct positions.

The unmanned access floor construction system according to an embodiment of the present invention includes an unmanned robot connected to a control server 1 through wired or wireless communication. In this case, the unmanned robot may include a loading robot 100 that loads the floor 30, an installation robot 200 that moves the floor 30 loaded on the loading robot 100 to the installation frame 10 to install the floor 30, and an alignment unit 300 that mounts the pad 20 on a pad installation position 32 of the floor 30 while the installation robot 200 moves the floor 30 to the installation frame 10 (see FIG. 10).

In general, the pad 20 is disposed at an edge including a vertex of the floor 30, and thus, an edge including a vertex of the adjacent floor 30 is coupled to the pad 20. When the floor 30 is provided in a square shape, the edge including the vertexes of four adjacent floors 30 are attached to the pad 20.

Thus, to install the plurality of adjacent floors 30 at the correct positions, the pad 20 of the floor 30 to be installed has to be coupled first to the installation frame 10 in the state of being accurately disposed at the pad installation position of the floor 30.

However, the installation robot in the unmanned access floor construction system so far had a problem in that it is difficult to accurately locate the pad 20 at the correct position on the floor 30, and thus, the pad 20 has to be installed first by manpower. Thus, the present invention has a feature that solves the above-described conventional problem by including the alignment unit 300 that aligns the pad 20 at the pad installation position 32 of the floor 30 as described below.

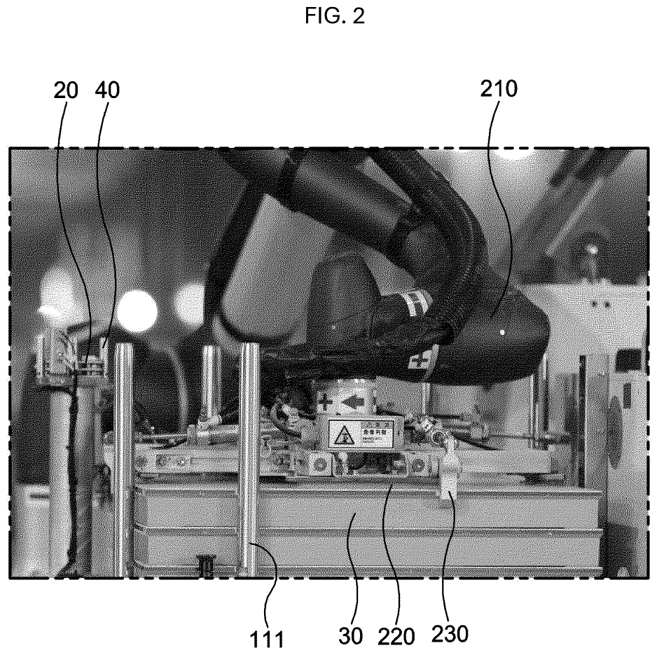

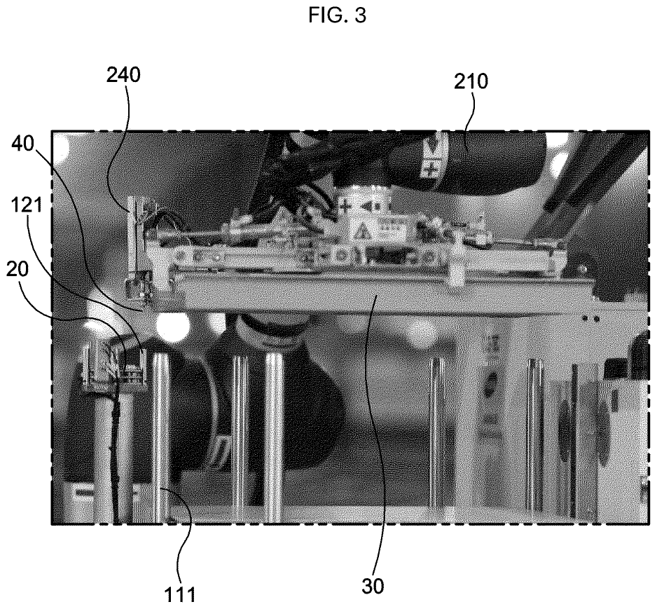

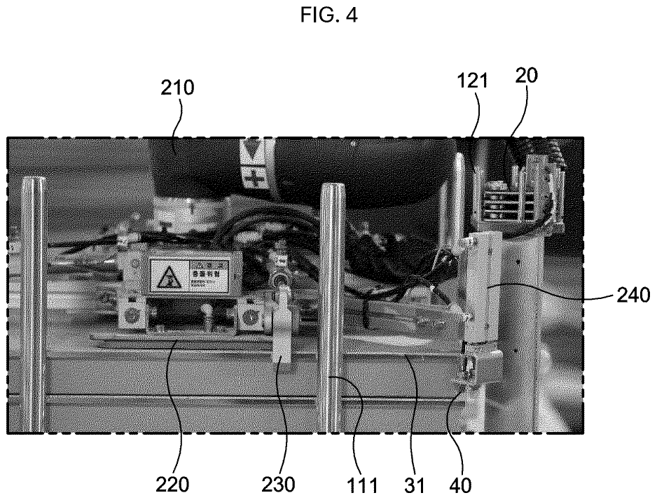

The installation robot 200 according to an embodiment of the present invention may include a robot arm 210, an adsorption part 220 disposed on the robot arm 210 to adsorb a top surface of the floor 30, and a latch 230 disposed on the robot arm 210 to surround a side hook protrusion 31 of the floor 30 (see FIGS. 2 and 4).

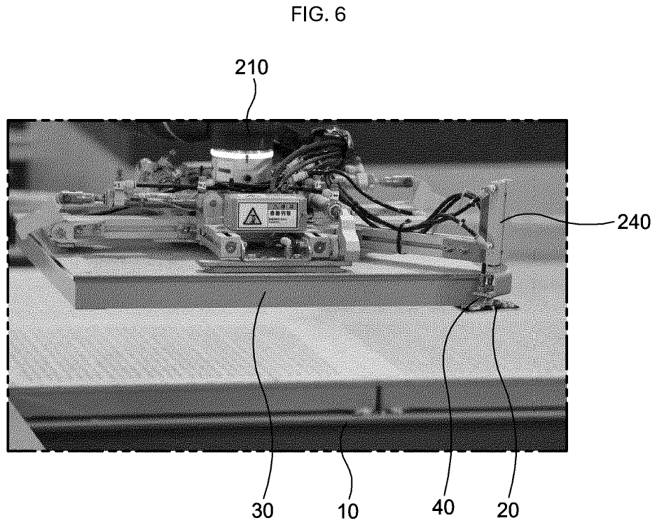

The installation robot 200 according to the present invention uses two types of lifting structures constituted by the adsorption part 220 and the latch 230. This is because, when the floor 30 is installed on the installation frame 10, since a side surface of the floor 30 and a side surface of an adjacent floor 30a are in close contact with each other, if the floor 30 approaches the installation position of the installation frame 10, the latch 230 is released to prevent an interference with the floor 30a from occurring, and the floor 30 is seated on the installation position by only using the adsorption part 220 (see FIGS. 6 to 8).

In comparison, when the robot arm 210 grips the floor 30 loaded on the loading robot 100 to lift the floor 30, there is a feature in which not only the adsorption part 220 that is adsorbed to the top surface of the floor 30, but also the latch 230 that surrounds the side surface of the floor 30 by latching the side hook protrusion 31 of the floor 30 is used together to improve stability of the movement.

The double griping structure according to the present invention may not only improve the stability of the transport of the floor 30, but also prevent the floor 30 from falling when the adsorption part 220 is malfunctioned.

The loading robot 100 according to an embodiment of the present invention may include a first loading part 110 that stacks and loads the plurality of floors 30 and a second loading part 120 that stacks and loads the plurality of pads 20 (see FIG. 10).

The first loading part 110 may include a guide rod 111 that prevents the plurality of loaded floors 30 from being separated and guides an upward movement direction of the floor 30 that is being lifted by the robot arm 210.

The second loading part 120 may also include a guide rod 121 that prevents the plurality of loaded pads 20 from being separated and guides an upward movement direction of the pad 20 that is being lifted by the robot arm 210.

The pad 20 may be gripped and lifted from the second loading part 120 by the pad installation part 240 of the robot arm 210 described later. The robot arm 210 may grip the floor 30 loaded on the first loading part 110 using the adsorption part 220 and also grip the pad 20, on which the pad installation part 240 of the robot arm 210 is loaded on the second loading part 120, to lift the pad 20, and thus, the pad installation part 240 may enable the pad 20 to be disposed at the pad installation position 32. However, since it is difficult to accurately locate the pad 20 at the pad installation position 32, the pad 20 may be adjusted to be disposed at the pad installation position 32 using the configuration of the alignment unit 300 described below.

The pad 20 according to an embodiment of the present invention may include a mounting part 21 on which an edge of the floor 30 is mounted, a guide protrusion 22 that partitions edges of the floor 30 and the adjacent floor 30a from each other, and a second through-hole 23 into which a bolt 40 for coupling the floor 30 and the pad 20 to the installation frame 10 is inserted (see FIG. 20).

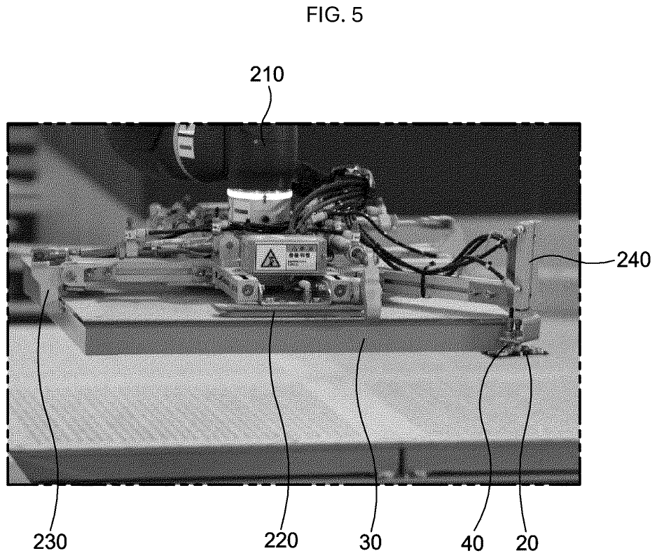

In addition, the installation robot 200 may include a pad installation part 240 that grips the pad 20 and inserts the bolt 40 into a first through-hole 32 and the second through-hole 23 (see FIG. 5).

The alignment unit 300 according to an embodiment of the present invention may include an alignment plate 310 on which the floor 30 and the pad 20 are mounted (see FIG. 10).

In this case, the alignment plate 310 may include a first mounting part 311 on which the floor 30 is mounted and a second mounting part 312 on which the pad 20 is mounted.

It is preferable that the alignment plate 310 is erected at a predetermined angle so that the floor 30 and the pad 20 gripped by the robot arm 210 are easily mounted.

When the floor 30 is mounted on the first mounting part 311, and the pad 20 is mounted on the second mounting part 312, the pad 20 may be accurately disposed at the pad installation position 32. For this, it is preferable that a mounting groove or support structure is prepared in consideration of a size of each of the floor 30 and the pad 20 and relative positions of the floor 30 and the pad 20.

According to an embodiment of the present invention, the alignment plate 310 may include constituents of a support protrusion 312 that supports the floor 30 so that the floor 30 is mounted on the first mounting part 311 and a support groove 314 into which the pad 20 is inserted so that the pad 20 is mounted on the second mounting part 312.

When the floor 30 and the pad 20 are mounted on the alignment plate 310, the pad 20 has to be inserted to a deeper position than the floor 30. Thus, the present invention has a feature in that the structure supporting the floor 30 is provided as a protrusion, and the structure supporting the pad 20 is provided as a groove.

When the pad 20 is accurately disposed at the pad installation position 32, the first through-hole 32 and the second through-hole 23, into which the bolt 40 disposed on the floor 30 is inserted, are aligned at the same position, and also, a lower edge of the floor 30 is in close contact with one side of the guide protrusion 22.

When the pad 20 is accurately disposed at the pad installation location 32 and fixed to the installation frame 10 together with the floor 30 by the bolt 40, the edge including one vertex of the adjacent floor 30 may be in close contact with the floor 30 and then installed to the installation frame 10 by being only seated on the already installed pad 20.

Hereinafter, an unmanned access floor construction method using the unmanned access floor construction system according to an embodiment of the present invention will be described.

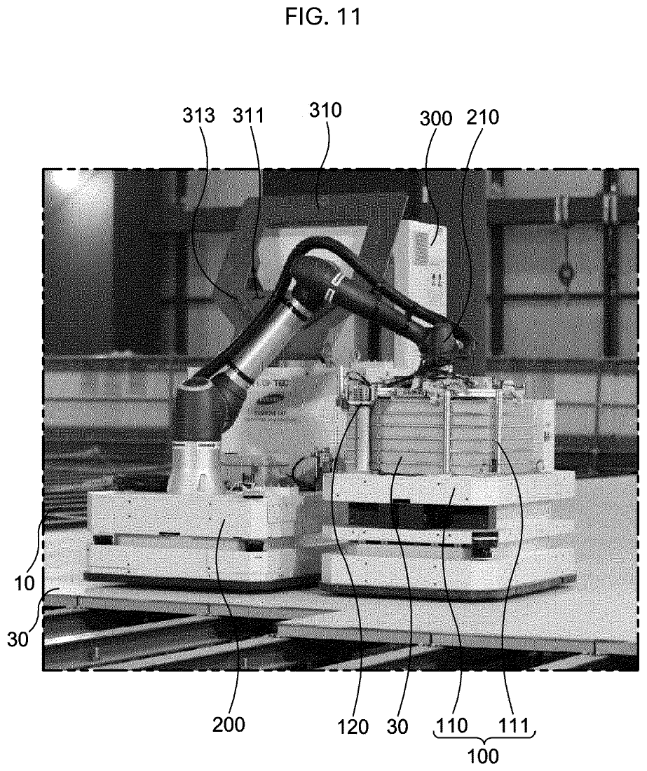

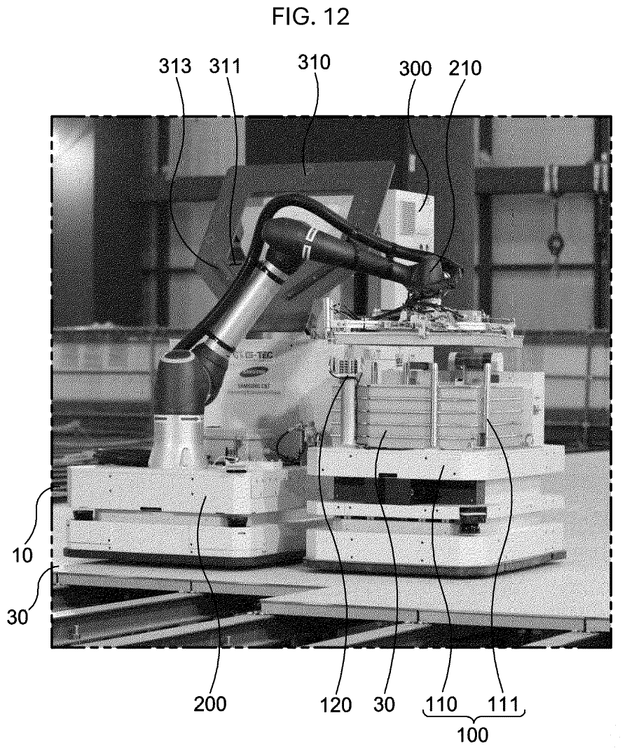

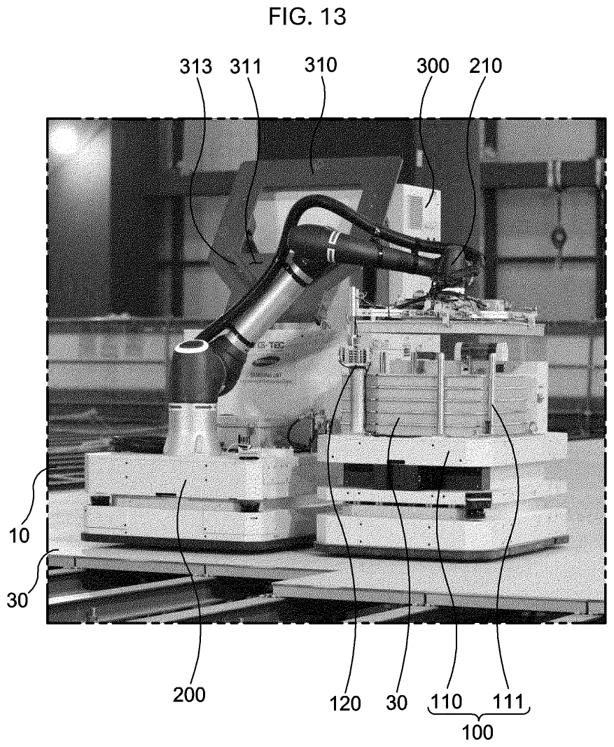

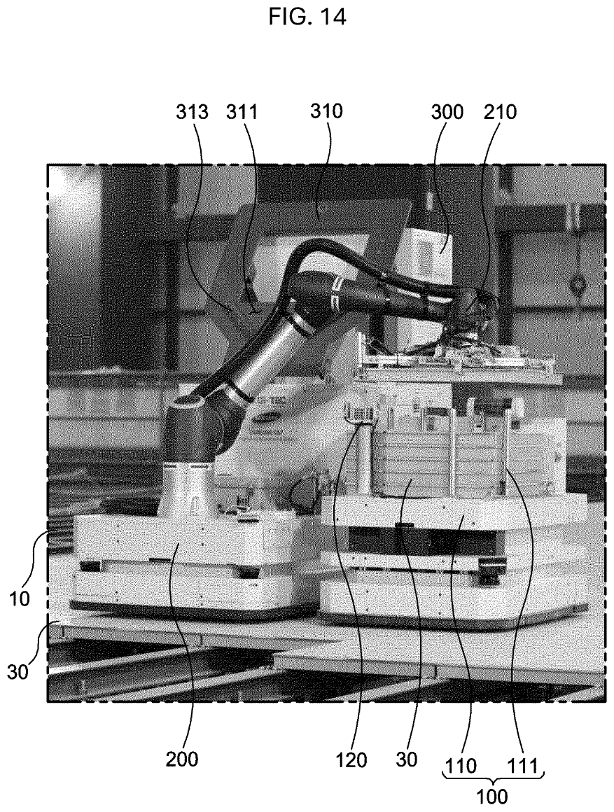

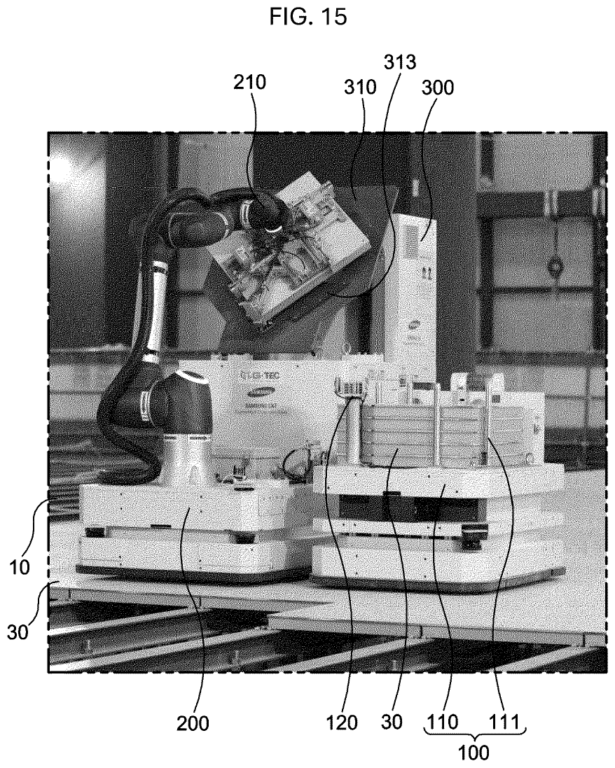

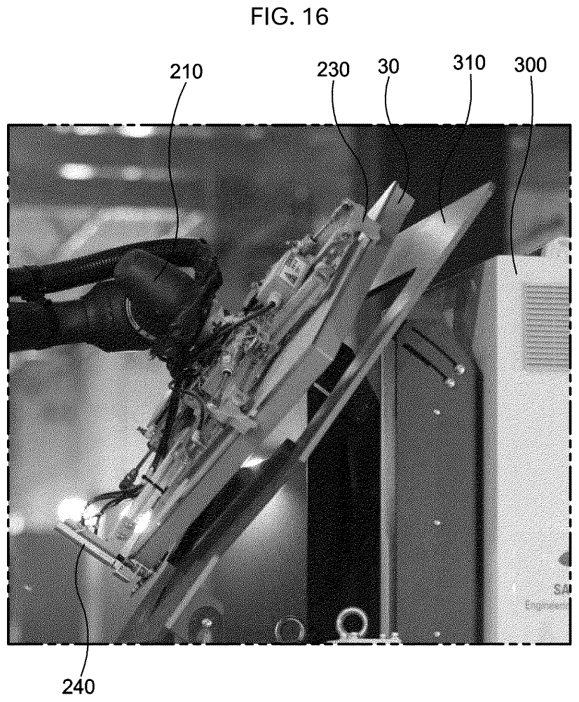

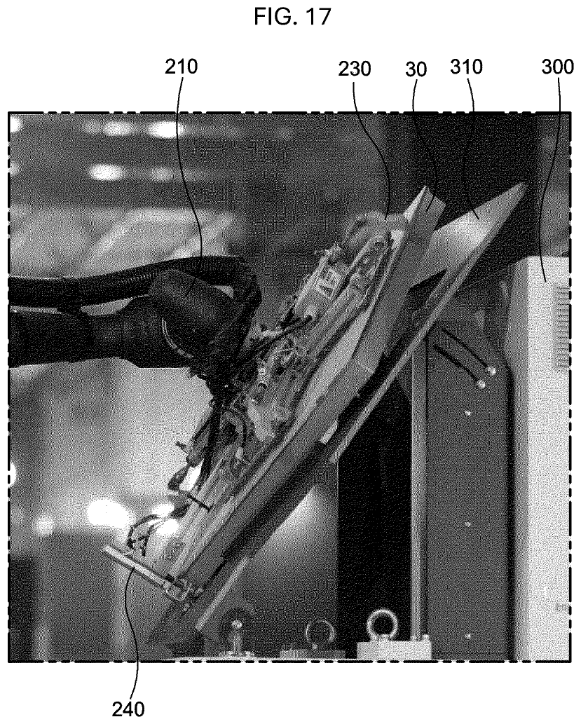

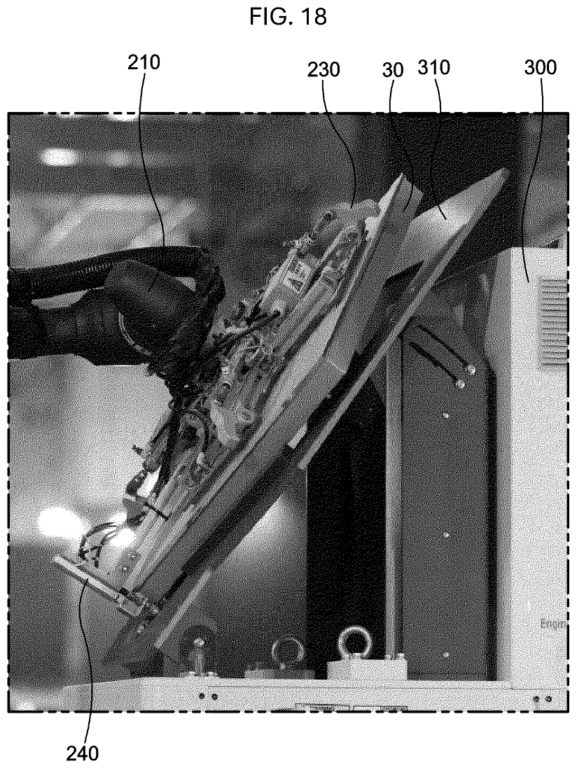

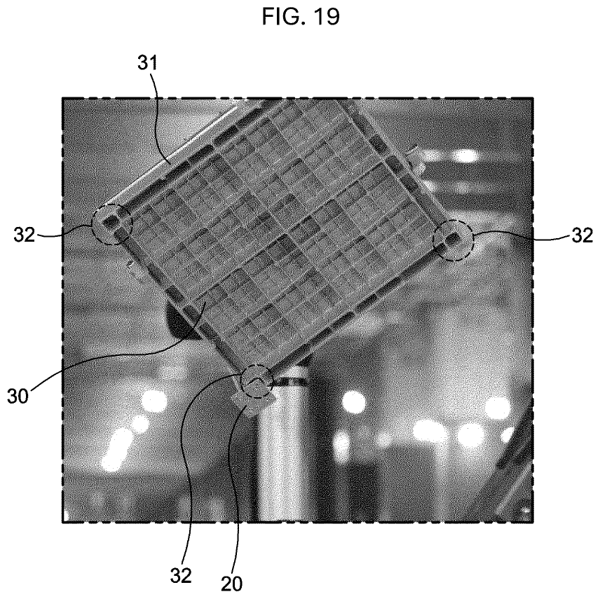

The unmanned access floor construction method according to the present invention may include a first process (S100, see FIGS. 10 to 12) of lifting a floor 30 loaded on a loading robot 100 using an adsorption part 220 and a latch 230 of an installation robot 200, a second process (S200, see FIGS. 13 and 14) of gripping a pad 20 using a pad installation part 240 of the installation robot 200 to lift the pad 20, a third process (S300, see FIGS. 15 to 19) of mounting the floor 30 on a first mounting part 311 and mounting the pad 20 on a second mounting part 312 to allow the pad 20 to be disposed at a pad installation position 32, and a fourth process (S400, see FIGS. 5 to 7) of mounting the pad 20 and the floor 30, which are mounted on an alignment plate 310, on an installation frame 10 using a robot arm 210 of the installation robot 200.

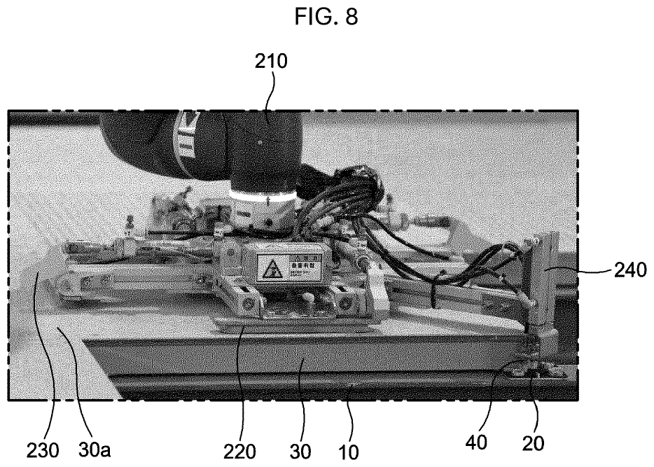

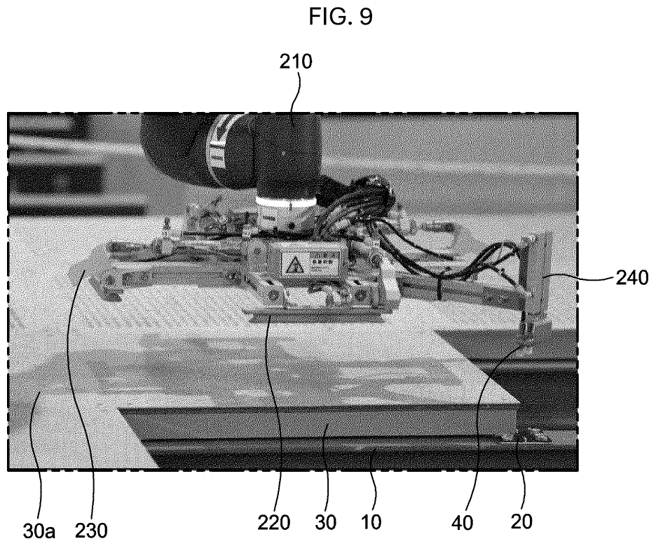

In this case, after the fourth process (S400), a fifth process (S500, see FIG. 8) of inserting a bolt 40 into a first through-hole 32 and a second through-hole 23 using the pad installation part 240 to couple the floor 30 to the installation frame 10 may be further performed.

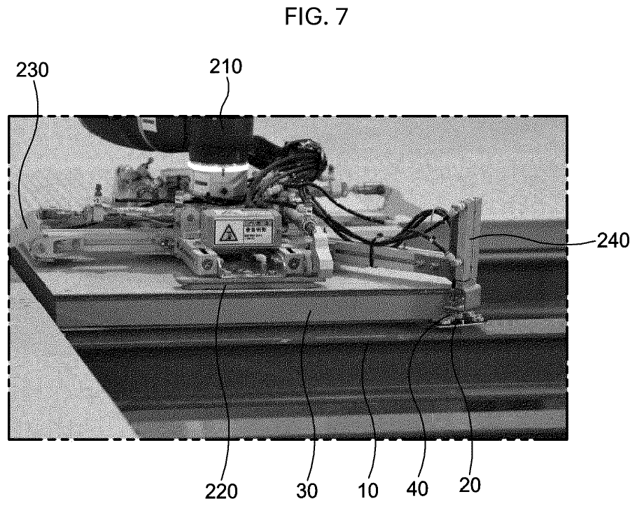

In addition, the fourth process (S400) may include a proximity movement process (S410, see FIG. 5) of lifting the pad 20 and the floor 30 using the robot arm 210 to move to a vicinity of the installation frame 10, a latch releasing process (S420, see FIG. 6) of hinge-driving a latch 230 in a state, in which adsorption of an adsorption part 220 on a top surface of the floor 30 is maintained, to release the latched state of the floor 30 on a side hook protrusion 31, and a seating process (S430, see FIG. 7) of seating the pad 20 and the floor 30 on a top surface of the installation frame 10.

According to the present invention, when performing the unmanned access floor construction, the lifting and seating of the floor may be stably performed, and also, since the pad is seated on the installation frame in the state in which the pad is accurately disposed at the installation position of the floor, there is an advantage in that the assembly quality is improved.

Although the above description merely corresponds to some exemplary embodiments that may be implemented by the present disclosure, as well known, the scope of the present disclosure should not be interpreted as being limited to the above-described embodiments, and all technical spirits having the same basis as that of the above-described technical spirit of the present disclosure are included in the scope of the present disclosure.

### INDUSTRIAL APPLICABILITY

The present invention is recognized as having industrial applicability in the construction fields.

### Sequence List Free Text

10: Installation frame
20: Pad
30: Floor
100: Loading robot
200: Installation robot
300: Alignment unit

1. An unmanned access floor construction system, which comprises an installation frame (10), floors (30) coupled to the installation frame (10), and pads (2) configured to couple the plurality of floors (30) at correct positions of the installation frame (10), the unmanned access floor construction system comprising:
an unmanned robot connected to a control server (1) through wired or wireless communication,
wherein the unmanned robot comprises:
a loading robot (100) configured to load each of the floors (30);
an installation robot (200) configured to move the floor (30) loaded on the loading robot (100) up to the installation frame (10) so as to install the floor (30); and
an alignment unit (300) configured to mount each of the pads (20) at a pad installation position (32) of the floor (30) when the installation robot (200) moves the floor (30) up to the installation frame (10).

2. The unmanned access floor construction system of claim 1, wherein the installation robot (200) comprises:
a robot arm (210);
an adsorption part (220) disposed on the robot arm (210) to adsorb a top surface of the floor (30); and
a latch (230) disposed on the robot arm (210) to surround a side hook protrusion (31) of the floor (30).

3. The unmanned access floor construction system of claim 2, wherein the loading robot (100) comprises:
a first loading part (110) configured to stack and load the plurality of floors (30); and
a second loading part (120) configured to stack and load the plurality of pads (20).

4. The unmanned access floor construction system of claim 3, wherein the pad (20) comprises:
a mounting part (21) on which an edge of the floor (30) is mounted;
a guide protrusion (22) configured to partition edges of the floor (30) and the adjacent floor (30a) from each other; and
a second through-hole (23) into which a bolt (40) configured to couple the floor (30) and the pad (20) to the installation frame (10) is inserted.

5. The unmanned access floor construction system of claim 4, wherein, when the pad (20) is disposed at the pad installation position (32), a first through-hole (32) and the second through-hole (23), into which the bolt (40) disposed on the floor (30) is inserted, are aligned at the same position, and a lower edge of the floor (30) is in close contact with one side of the guide protrusion (22).

6. The unmanned access floor construction system of claim 5, wherein the installation robot (200) comprises a pad installation part (240) configured to grip the pad (20) and insert the bolt (40) into the first through-hole (32) and the second through-hole (23).

7. The unmanned access floor construction system of claim 6, wherein the alignment unit (300) comprises an alignment plate (310) on which the floor (30) and the pad (20) are mounted,
wherein the alignment plate (310) comprises:
a first mounting part (311), on which the floor (30) is mounted; and
a second mounting part (312), on which the pad (20) is mounted.

8. The unmanned access floor construction system of claim 7, wherein, when the floor (30) is mounted on the first mounting part (311), and the pad (20) is mounted on the second mounting part (312), the pad (20) is disposed at the pad installation position (32).

9. The unmanned access floor construction system of claim 8, wherein the alignment plate (310) is erected at a predetermined angle.

10. The unmanned access floor construction system of claim 9, wherein the alignment plate (310) further comprises a support protrusion (313) configured to support the floor (30) so that the floor (30) is mounted on the first mounting part (311).

11. The unmanned access floor construction system of claim 10, wherein the alignment plate (310) further comprises a support groove (314) in which the pad (20) is inserted so that the pad (20) is mounted on the second mounting part (312).

12. An unmanned access floor construction method using the unmanned access floor construction system of claim 11, the unmanned access floor construction method comprising:
a first process (S100) of lifting the floor (30) loaded on the loading robot (100) using the adsorption part (220) and the latch (230) of the installation robot (200);
a second process (S200) of gripping the pad (20) using the pad installation part (240) of the installation robot (200) to lift the pad (20);
a third process (S300) of mounting the floor (30) on the first mounting part (311) and mounting the pad (20) on the second mounting part (312) to allow the pad (20) to be disposed at the pad installation position (32); and
a fourth process (S400) of mounting the pad (20) and the floor (30), which are mounted on the alignment plate (310), on the installation frame (10) using the robot arm (210) of the installation robot (200).

13. The unmanned access floor construction method of claim 12, further comprising, after the fourth process (S400), a fifth process (S500) of inserting the bolt (40) into the first through-hole (32) and the second through-hole (23) using the pad installation part (240) to couple the floor (30) to the installation frame (10).

14. The unmanned access floor construction method of claim 13, wherein the fourth process (S400) comprises:
a proximity movement process (S410) of lifting the pad (20) and the floor (30) using the robot arm (210) to move to a vicinity of the installation frame (10);
a latch releasing process (S420) of hinge-driving the latch (230) in a state, in which the adsorption of the adsorption part (220) on a top surface of the floor (30) is maintained, to release the latched state of the floor (30) on the side hook protrusion (31); and
a seating process (S430) of seating the pad (20) and the floor (30) on a top surface of the installation frame (10).

15. An access floor constructed through the unmanned access floor construction method of FIG. 14.
